(19) United States
(12) Patent Application Publication
(10) Pub. No.: US 2017/0159358 A1
(43) Pub. Date: Jun. 8, 2017

(54) Roller Blind

(71) Applicant: Llaza World, S.A., Alcover (ES)

(72) Inventor: David ALONSO FABREGAT, Alcover (ES)

(21) Appl. No.: 15/320,823

(22) PCT Filed: Jun. 23, 2015
(86) PCT No.: PCT/ES2015/070484

§ 371 Date: Dec. 21, 2016

(30) Foreign Application Priority Data
Jun. 30, 2014 (ES) P201430979

(51) Int. Cl. E06B 9/58

(52) U.S. Cl. CPC E06B 9/581

(57) ABSTRACT

A roller blind having a canvas, a winding shaft to roll up the canvas, a load bar, and two guides, each defining therein a cavity and being provided with a slit through which the canvas is inserted. The canvas includes on each of its side edges a hem, said hem being configured to be housed inside the cavity, wherein the hem forms a tube including therein a retaining strip. The cross sectional area of said tube is greater than the cross sectional area of the retaining strip, and said hem thickness is greater than the width of the slit into which it is inserted.

The present invention relates to a roller blind or windbreaker curtain, comprising a canvas arranged vertically and fastened by its side edges to guides. In particular, the roller blind of the present invention ensures correct operation when there are gusts of wind and at the same time, it is less sensitive to manufacturing and assembly tolerances.

### BACKGROUND OF THE INVENTION

Roller blinds are known in the state of the art comprising a canvas, a winding shaft to roll up the canvas coupled to a first edge thereof, a load bar coupled to a second canvas edge, opposite the first edge, and two guides extending longitudinally along the direction of movement of the canvas (usually the vertical direction, although in some cases it can also be the horizontal direction or a direction at an inclination to the horizontal direction), each defining a cavity within it and being provided with a slit through which the canvas is inserted.

These blinds have the disadvantage that when wind blows, canvas areas which were inserted into the guides may come out, leading to a bagging effect that degrades the aesthetics of the blind and that of the canvas material. In addition, due to the holes created between the guide and the edge of the canvas in areas where the canvas has come out of the guide, the blind stops performing its function of comprehensive sun protection, blocking light and as a protection against wind.

An attempt to solve this problem is to place retaining elements on the side edges (or perpendicular to the winding shaft) of the canvas which are housed in the cavity of the guides of the blind, forming a structure similar to a half zip. These retaining elements are larger in thickness than the slit width of the guides to prevent the canvas from coming out of the guides. Patents ES106579U, AU2009212839 and CN201095948U show some examples of roller blinds with retaining elements (also called zipper type system or zip blinds).

However, this solution has several drawbacks. First, the slit on the guide needs to be very narrow to prevent the retaining elements from coming out, thus increasing the friction of the canvas with the slit. This, on the one hand accelerates wear of the canvas and, secondly, it forces the use of heavier load bars to overcome the resistance to movement caused by friction.

Furthermore, the system is very sensitive to tolerances in the installation of the blind. For example, a slight inclination of the guides with respect to the vertical can cause the retaining elements, or even the load bar itself, to become stuck against the slit in the guide.

The state of the art also discloses roller blinds in which the retaining element consists of a hem on each of the side edges of the canvas, which is obtained from the superposition of several layers of material forming the canvas, and it can be housed inside the cavity of each of the guides. Patent WO2014/009573 discloses a roller blind of this type.

This solution, compared to the previous one, is simpler to manufacture since there is no need to secure a plurality of retaining elements along the side edges of the canvas, either by stitching or welding. However, the hem solution does not solve the problems described.

It would therefore be desirable to have a roller blind with a protection system against gusts of wind which presents less friction of the retaining elements with the slit and is less sensitive to manufacturing and assembly tolerances.

### DESCRIPTION OF THE INVENTION

The roller blind according to claim 1 solves the aforesaid disadvantages, presenting other advantages that will be described.

One aspect of the present invention relates to a roller blind, comprising: a canvas; a winding shaft to roll up the canvas, said shaft being coupled to a first edge of the canvas; a load bar coupled to a second edge of the canvas, the second edge being opposite the first edge; and two guides extending longitudinally along the direction of movement of the canvas, each defining a cavity therein and being provided with a slit through which the canvas is inserted into said cavity; wherein the canvas comprises at each of its side edges, perpendicular to the winding shaft, a hem (sometimes also referred to as bag) said hem being adapted to be housed in said cavity of each of the guides. This roller blind is characterized in that the hem on each of the side edges of the canvas forms a tube (also referred to as conduit, or channel of closed cross section) comprising therein a retaining strip disposed along said tube; wherein the cross sectional area of said tube is greater than the cross sectional area of the retaining strip; and wherein the thickness of said hem with the retention strip housed inside its tube is greater than the width of the slit of the guide into which it is inserted, preventing the hem from completely coming out of the guide.

As the cross sectional area of the tube of the hem is greater than the section area of the retaining strip, the retaining strip is arranged loosely inside the hem tube. Thus, the retaining strip is pressed against the slit of the guide only when there is a gust of wind that tends to drag the hem of the canvas outside of the cavity. Accordingly, the roller blind of the present invention reduces the friction between the canvas and the slit.

This slack also allows to absorb errors in the canvas slide, for example due to tolerances in the guide assembly. Therefore, as the retention strip can move inside the hem tube, the risk of it getting stuck with the guide slit is reduced.

Furthermore, the roller blind of the present invention is less sensitive to canvas manufacturing tolerances, unlike blinds of the prior art with retaining elements fitted on both canvas edges, wherein the precision in aligning the retaining elements forming the half zipper is usually critical.

The looseness provided by the hem tube also facilitates the insertion of the retaining strip during assembly. Furthermore, when the canvas blind is wound, the looseness of the tube enables the retaining strip to be positioned differently for each canvas turn around the winding shaft, thereby achieving a more compact winding.

In the context of the present invention, the thickness preferably refers to the dimension in a direction perpendicular to the direction in which the guide slit extends.

Advantageously, since the canvas hem is thickened with the retaining strip inside the hem tube, the slit in the guides does not need to be very narrow, unlike what happens with blinds in which the canvas hem is formed by merely superimposing several layers of material. Therefore, slits can use a wider range of widths and having more conventional values tan those used in the prior art.

In some cases, the retaining strip comprises a first end coupled to the first edge of the canvas and/or to the winding shaft and a second end coupled to the second edge of the canvas and/or to the load bar.

Thus, it is not necessary for the retaining strip to be fastened either by sewing or by welding, at intermediate points of the tube, which simplifies the manufacture of the blind. Furthermore, in the case where the retaining strip is coupled to the winding shaft and the load bar, the retaining strip also acts to guide movement of the canvas.

The cross sectional area of the hem tube is preferably at least twice the cross sectional area of the retaining strip housed inside. However, in some cases the cross-sectional area of the hem tube is advantageously at least three, four or even five times the cross sectional area of the retaining strip housed inside.

In some embodiments, the retaining strip comprises a longitudinal connecting member disposed along the hem tube, and a plurality of retaining elements joined to said longitudinal connecting member; wherein the thickness of the longitudinal connecting member is smaller than the thickness of the retaining elements.

Preferably, in these embodiments, the thickness of said retaining elements is greater than the width of the guide slit in which the hem is inserted. Thus, the retaining effect is ensured regardless of the thickness of the canvas material used.

In the context of the present invention, the thickness of a retaining element, which can be generally irregular, preferably refers to the maximum dimension of said element in a direction perpendicular to the direction in which the guide slit extends.

Also preferably, said retaining elements have a spherical or cylindrical shape. The use of rounded shapes is particularly advantageous because they reduce the risk of retaining elements being pinched by the hem. However, in other cases, the retaining elements may have other shapes.

Advantageously, in one embodiment said retaining elements are integrally formed of a synthetic or plastic material. Alternatively, the retaining elements can be metallic. In one and other case, preferably the retaining elements are moulded by casting or injection on the longitudinal connecting member. Thus, the holding elements are secured to the longitudinal connecting member without additional fastening means

In certain embodiments, the longitudinal connecting member is integrally formed of a flexible material. The flexibility of the material of the longitudinal connecting member (particularly in the longitudinal direction) facilitates the winding operation of the canvas and also allows it to be wound compactly.

Optionally, the longitudinal connecting member and the plurality of retaining elements are formed of the same material. This facilitates the manufacturing process of the retaining strip, which can be obtained by integrally by moulding a synthetic or plastic material.

In other embodiments, the longitudinal connecting member is a cord or chain. This solution is particularly economical due to the simplicity of materials used.

Preferably, the retaining elements are regularly spaced along the longitudinal connecting member. Thus, the retaining capacity of the canvas remains uniform throughout the extent thereof. Moreover, the spacing between the retainers allows winding one turn of canvas hem over another without the retaining elements overlapping, allowing a smaller winding diameter of the canvas, when fully rolled up.

In certain embodiments, all the retaining elements have the same thickness; and preferably the spacing between the retaining elements is less than three times said thickness. In some of these embodiments, the spacing may be less than twice or even one time, said thickness.

If the separation between the retaining elements is very large, a gust of wind could drag the hem out of the guide in the intermediate zone between two consecutive retaining elements. Selected spacing ranges prevent this from happening, thereby providing a good behaviour of the retaining strip.

Preferably also the two retaining strips of the roller blind, each housed inside the hem tube of each of the two side edges of the canvas, are equal. This is advantageous to ensure that the behaviour of the blind against gusts of wind is the same in both side edges.

Advantageously, in some cases each of these guides is formed by two guide profiles coupled to each other that, once coupled, determine said cavity and said slit. The use of attachable guide profiles facilitates the installation and assembly of the roller blind.

In these cases preferably each of said guides includes a guard profile comprising a first portion disposed within the cavity determined by the two guide profiles; and wherein said first portion comprises a recess adapted to receive inside the canvas hem and a slot aligned with the slit determined by the two guide profiles

Said guard profile, preferably made of plastic, prevents the canvas hem from wear due to rubbing against the inside of the guide profiles that determine the cavity.

More preferably the guard profile comprises two outer portions, each connected to one end of the slot of the first portion, projecting from the cavity through the slit determined by the two guide profiles.

The outer portions prevent the canvas hem from rubbing directly on the slit in the guide, which may deteriorate it. Moreover said portions contribute to reducing the width of the slit, preventing that the canvas hem (with the retention strip housed inside the tube) may completely come out of the guide.

### BRIEF DESCRIPTION OF THE FIGURES

For a better understanding of what has been outlined, some drawings are attached which, schematically and solely by way of non-limiting example, show a practical case of an embodiment.

FIG. 1 shows a roller blind according to the present invention.

FIG. 2 shows, in a perspective view, a section of the roller blind according to a plane perpendicular to the direction of movement of the canvas, which shows the arrangement of the canvas hem and of the retaining strip, inside the cavity of the roller blind guide.

FIG. 3 corresponds to a plan view of the same section shown in FIG. 2.

FIG. 4 shows a front view of the same section of roller blind of FIG. 2.

FIG. 5 shows an example of the retaining strip according to the present invention.

FIG. 6 represents a plan view of one of the roller blind guides consisting of two guide profiles which can be coupled to each other.

### DESCRIPTION OF A PREFERRED EMBODIMENT

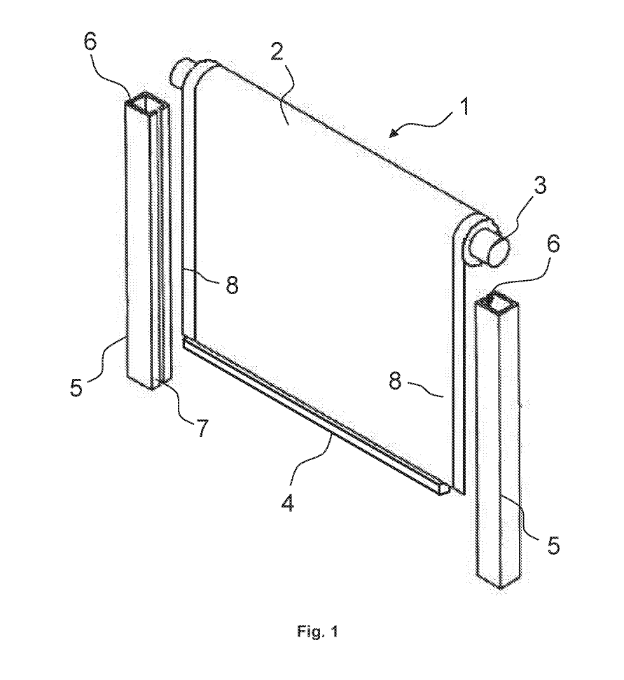

FIG. 1 shows an embodiment of the roller blind according to the present invention. In particular, the roller blind 1 comprises: a canvas 2; winding shaft 3 coupled to a first edge of the canvas 2 in order to roll it up; a load bar 4 coupled to a second canvas edge 2 opposite the first edge; and two guides 5 extending longitudinally along the direction of movement of the canvas 2, in this example the vertical direction. Each guide 5 defines inside it a cavity 6 and is provided with a slit 7 through which the canvas 2 is inserted. The canvas 2 comprises in each of its side edges, perpendicular to the winding shaft 3, a hem 8 which can be housed inside the cavity 6 of each of the guides 5.

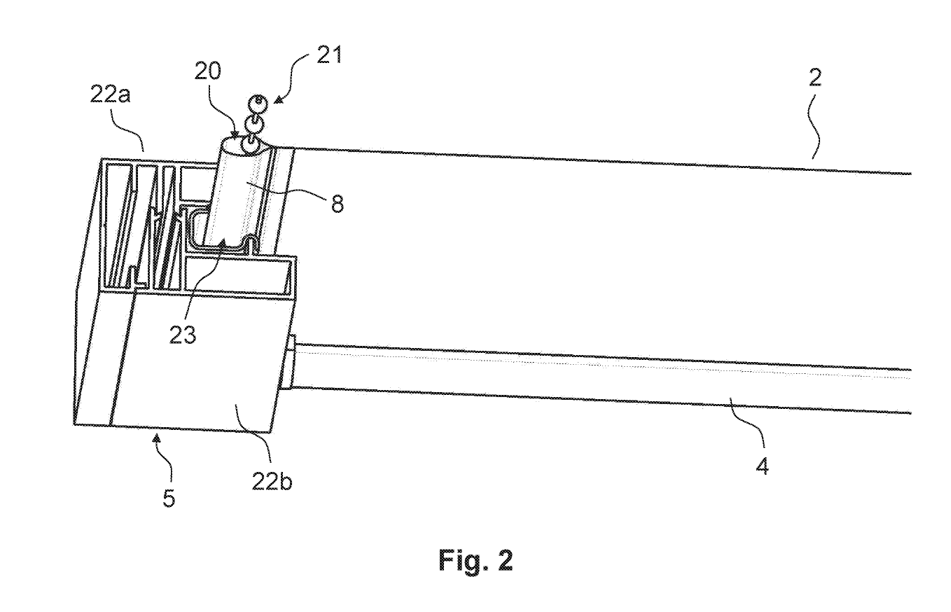

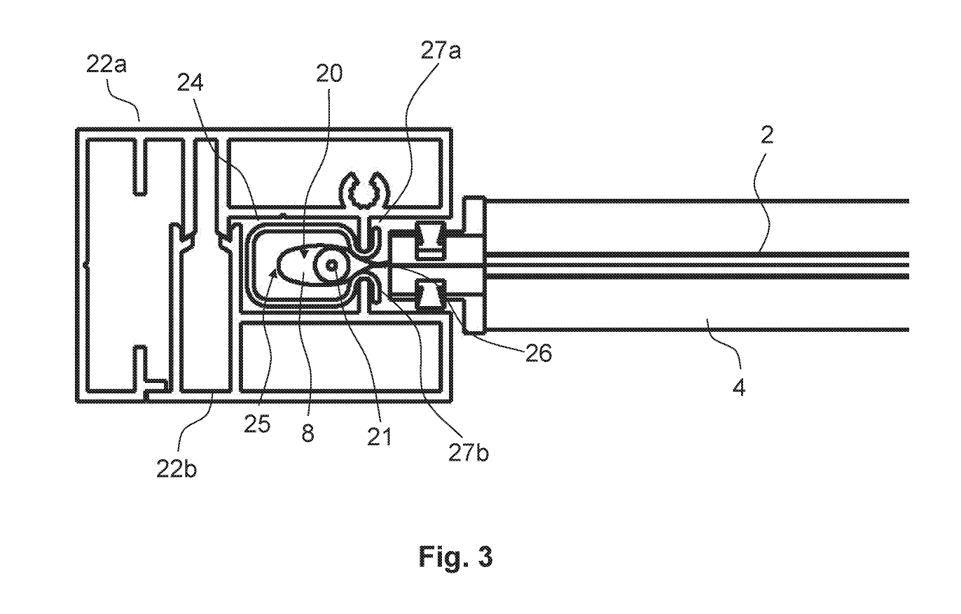

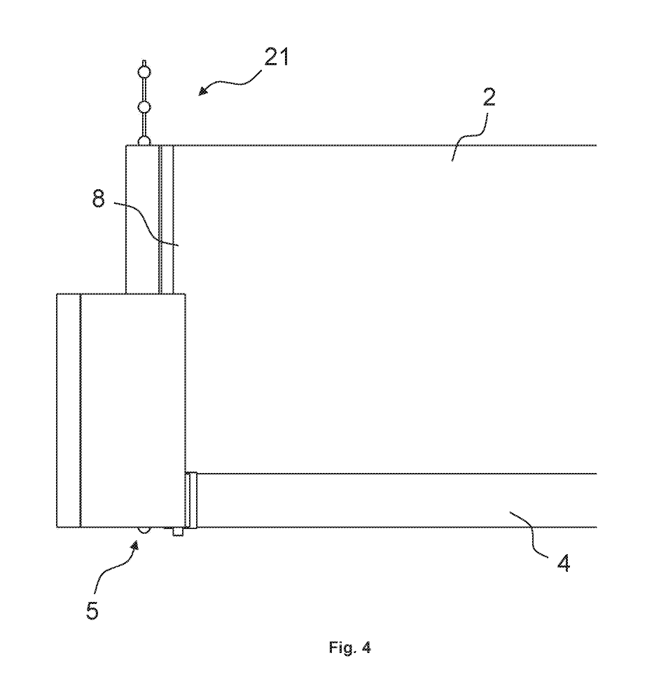

FIGS. 2-4 show a section of the roller blind according to a plane perpendicular to the direction of movement of the canvas, which shows in more detail the arrangement of the canvas hem, with its retaining strip, inside the cavity of the guide of the roller blind according to the present invention. Although the figures show only one of the two guides of the roller blind 1, the other guide structure is identical. FIG. 2 is a perspective view, while FIGS. 3 and 4 provide additional plan and front views, respectively.

The hem 8 in each of the side edges of the canvas 2 forms a tube 20 which comprises inside it a retaining strip 21 disposed along the tube 20. The retaining strip 21 comprises a first end coupled to the first edge of the canvas 2 and a second edge coupled to the second end of the canvas 2, without needing to secure the tube 20 at intermediate points.

The cross sectional area of the tube 20 of the hem 8 is greater than the cross sectional area of the retaining strip 21. More specifically, as can be seen in FIG. 3, the cross section of said tube 20 is at least twice the cross sectional area of the retaining strip 21 housed therein.

The thickness of the hem 8 with the retaining strip 21 housed inside its tube 20 is greater than the width of the slit 7 of the guide 5 in which it is inserted, thereby preventing the hem 8 from completely coming out of the guide 5.

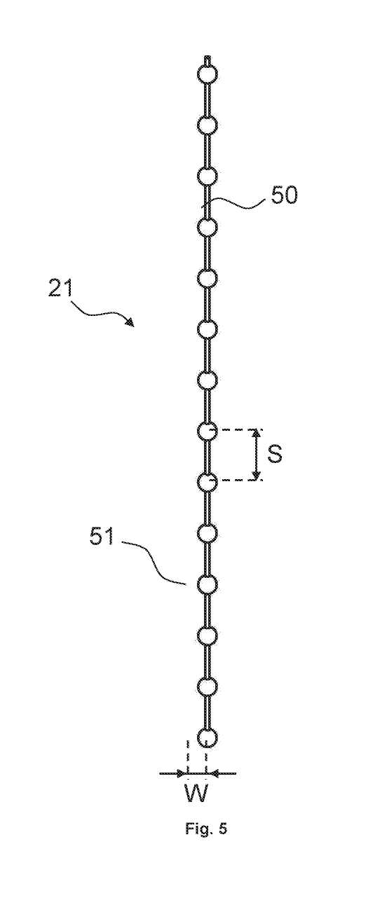

FIG. 5 shows a fragment of the retaining strip 21 comprising a longitudinal connecting member 50 disposed along the tube 20 of the hem 8, and a plurality of retaining elements 51 joined to said longitudinal connecting member 50. The figure shows how the thickness of the longitudinal connecting member 50 is smaller than the thickness of the retaining elements 51. Although in this example all the retaining elements 51 are equal, in other examples they may have different shapes and/or thicknesses.

In particular, the retaining elements 51 have a spherical shape and a thickness W greater than the width of the slit 7 of the guide 5 in which the hem 8 is inserted.

In the embodiment of the figures, the longitudinal connecting member 50 is a cord and the retaining elements 51 are integrally formed of a synthetic or plastic material moulded onto said cord.

As shown in FIG. 5, the retaining elements 51 are regularly spaced along the longitudinal connecting member 50. More specifically, the spacing S between the retaining elements is less than three times its thickness W.

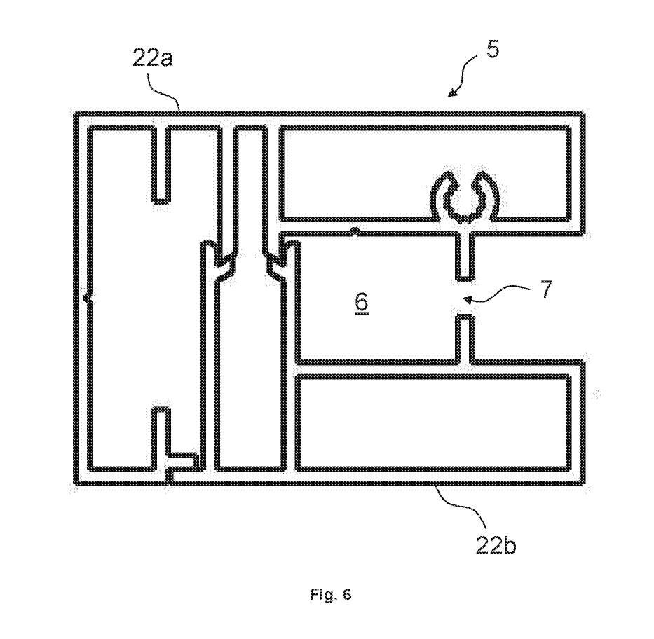

As shown in FIG. 6, each of the guides 5 of the roller blind 1 is made up of two guide profiles 22a, 22b which can be coupled together, that once coupled, determine the cavity 6 and the slit 7 of the guide 5.

Additionally, each of said guides 5 includes a guard profile 23 comprising a first portion 24 disposed within the cavity 6 determined by the two guide profiles 22a, 22b. Said first portion 24 comprises a recess 25 adapted to receive the hem 8 of the canvas 2 in its interior and a slot 26 aligned with the slit 7 determined by the two guide profiles 22a, 22b

The guard profile 23 also comprises two outer portions 27a, 27b, each connected to one end of the slot 26 of the first portion 24, protruding from the cavity 6 through the slit 7 determined by two guide profiles 22nd 22b.

Although reference has been made to a specific embodiment of the invention, it is apparent to one skilled in the art that the roller blind described is susceptible of numerous variations and modifications, and that all the details mentioned can be replaced with other technically equivalent ones without departing from the scope of protection defined by the appended claims.

1. A roller blind, comprising: a canvas; a winding shaft to roll up the canvas, said shaft being coupled to a first edge of the canvas; a load bar coupled to a second edge of the canvas, the second edge being opposite the first edge; and two guides extending longitudinally along a direction of movement of the canvas, each defining therein a cavity and being provided with a slit through which the canvas is inserted in said cavity; wherein the canvas comprises in each of its side edges perpendicular to the winding shaft, a hem, said hem being adapted to be housed inside the cavity of each of the guides; wherein the hem in each of the side edges of the canvas forms a tube comprising therein a retaining strip disposed along said tube; wherein a cross sectional area of said tube is greater than a cross sectional area of the retaining strip; and wherein a thickness of said hem with the retaining strip housed inside the tube is greater than a width of the slit of the guide in which it is inserted preventing the hem from completely coming out of the guide.

2. The roller blind according to claim 1, wherein the retaining strip comprises a first end coupled to the first edge of the canvas and/or the winding shaft, and a second end coupled to the second edge of the canvas and/or the load bar.

3. The roller blind according to claim 1, wherein the cross sectional area of the tube of the hem is at least twice the cross sectional area of the retaining strip housed inside.

4. The roller blind according to claim 1, wherein the retaining strip comprises: a longitudinal connecting member disposed along the tube of the hem, and a plurality of retaining elements attached to said longitudinal connecting member; wherein a thickness of the longitudinal connecting member is smaller than a thickness of the retaining elements.

5. The roller blind according to claim 4, wherein the thickness of said retaining elements is greater than the width of the slit of the guide in which the hem is inserted.

6. The roller blind according to claim 4, wherein said retaining elements have a spherical or cylindrical shape.

7. The roller blind according to claim 4, wherein said retaining elements are integrally formed of a synthetic or plastic material.

8. The roller blind according to claim 4, wherein the longitudinal connecting member is integrally formed of a flexible material.

9. The roller blind according to claim 4, wherein the longitudinal connecting member is a cord or a chain.

10. The roller blind according to claim 4, wherein the retaining elements are spaced regularly along the longitudinal connecting member.

11. The roller blind according to claim 4, wherein all the retaining elements have a same thickness; and wherein preferably a spacing between the retaining elements is less than three times said same thickness.

12. The roller blind according to claim 1, wherein the two retaining strips of the roller blind, each housed inside the tube of the hem of each of the two side edges of the canvas, are equal.

13. The roller blind according to claim 1, wherein each of said guides is formed by two guide profiles which are configured to be coupled together such that, once coupled, the two guide profiles determine said cavity and said slit.

14. The roller blind according to claim 13, wherein each of said guides comprises a guard profile comprising a first portion disposed inside the cavity determined by the two guide profiles; and wherein said first portion comprises a recess configured to receive the hem of the canvas therein and a slot aligned with the slit determined by the two guide profiles.

15. The roller blind according to claim 14, wherein the guard profile comprises two outer portions, each connected to one end of the slot of the first portion, which protrude from the cavity through the slit determined by the two guide profiles.
